(19) United States
(12) Patent Application Publication
(10) Pub. No.: US 2009/0017364 A1
(43) Pub. Date: Jan. 15, 2009

(54) METHODS FOR IMPROVING LITHIUM ION BATTERY SAFETY

(75) Inventor: Veselin Manev, Reno, NV (US)

Correspondence Address: MORRISON & FOERSTER LLP, 425 MARKET STREET, SAN FRANCISCO, CA, 94105-2482, US

(73) Assignee: Altairnano, Inc., Reno, NV (US)

(21) Appl. No.: 12/016,973

(22) Filed: Jan. 18, 2008

Related U.S. Application Data
(60) Provisional application No. 60/885,572, filed on Jan. 18, 2007.

(51) Int. Cl. H01M 10/44; H01M 4/48; H02J 7/00; H01M 4/50

(52) U.S. Cl. 429/50; 429/231.5; 429/224

(57) ABSTRACT

The methods and apparatus described herein include, in some variations, a method of powering an electronic device with a lithium ion cell that has a cathode and an anode. The anode is made, at least in part, of nano-crystalline Li₄Ti₅O₁₂. The lithium ion cell is charged. The lithium ion cell is discharged to power the electronic device. The charging and discharging can take place within a temperature range between 130° C. and 250° C. and voltage range between 1.5 V and 4.2 V, and will results in a safety coefficient greater than 100.

### CROSS REFERENCE TO RELATED APPLICATIONS

This application claims the benefit under 35 USC 119(e) of U.S. Provisional Application Ser. No. 60/885,572, filed Jan. 18, 2007, the contents of which are hereby incorporated by reference in the present disclosure in their entirety.

### FIELD OF INVENTION

The methods described herein relate to lithium ion batteries and methods of improving the safe operation of such batteries.

### BACKGROUND OF THE INVENTION

The majority of portable electronic devices utilize high capacity lithium ion batteries, from small-scale apparatus such as cellular phones, portable computers, and video cameras, to larger devices such as power tools, hybrid vehicles, construction equipment, and aircraft.

Traditional lithium power batteries exhibit significant problems if operated outside a narrow range of temperatures and voltages. For instance, traditional lithium batteries suffer from thermal runaway problems above 130° C. and can be potentially explosive. When such a lithium ion battery is short-circuited or overcharged due to device malfunction or erroneous use, the temperature increases can accelerate, and gas may be generated in the battery that increase the pressure.

A variety of safety mechanisms such as pressure release valves, one-shot fuses, reversible and irreversible positive temperature coefficient elements, shutdown separators, chemical shuttles, and non-flammable electrolytes and coatings, have been engineered into the batteries to avoid thermal runaway and potential explosion. Furthermore, expensive and sophisticated electronic circuitry is often required to keep cells in charge and voltage balanced.

Despite past engineering efforts, there is still a need for lithium ion batteries that exhibit enhanced safety and a wider range of safe operational conditions.

### BRIEF SUMMARY OF THE INVENTION

The methods and apparatus described herein include, in some variations, a method of powering an electronic device with a lithium ion cell that has a cathode and an anode. The anode is made, at least in part, of nano-crystalline Li₄Ti₅O₁₂. The lithium ion cell is charged. The lithium ion cell is discharged to power the electronic device. The charging and discharging can take place within a temperature range between 130° C. and 250° C. and voltage range between 1.5 V and 4.2 V, and will result in a safety coefficient greater than 100. In some variations, the cathode is made, at least in part, of LiMn₂O₄. In some variations, the lithium ion cell does not contain a solid electrolyte interface layer. In some variations, the lithium ion cell comprises an aluminum current collector. In some variations, the lithium ion cell does not include a copper current collector. In some variations, the lithium ion cell has a cycle life of at least 3,000 cycles. In some variations, the lithium ion cell has a calendar life of 5-9 years. In some variations, the lithium ion cell has a calendar life of 10-15 years. In some variations, the lithium ion cell does not contain lead, nickel, cadmium, acids, or caustics in the electrolyte solution.

The methods and apparatus described herein include, in some variations, a method of powering an electronic device with a lithium ion cell that has a cathode and an anode. The anode is made, at least in part, of nano-crystalline Li₄Ti₅O₁₂. The lithium ion cell is charged. The lithium ion cell is discharged to power the electronic device. The charging and discharging can take place within a temperature range between −50° C. and 5° C. and voltage range between 1.5 V and 4.2 V, and will result in a safety coefficient greater than 100. In some variations, the cathode is made, at least in part, of LiMn₂O₄. In some variations, the lithium ion cell does not contain a solid electrolyte interface layer. In some variations, the lithium ion cell comprises an aluminum current collector. In some variations, the lithium ion cell does not include a copper current collector. In some variations, the lithium ion cell has a cycle life of at least 3,000 cycles. In some variations, the lithium ion cell has a calendar life of 5-9 years. In some variations, the lithium ion cell has a calendar life of 10-15 years. In some variations, the lithium ion cell does not contain lead, nickel, cadmium, acids, or caustics in the electrolyte solution.

The methods and apparatus described herein include, in some variations, a method of powering an electronic device with a lithium ion cell that has a cathode and an anode. The anode is made, at least in part, of nano-crystalline Li₄Ti₅O₁₂. The lithium ion cell is charged. The lithium ion cell is discharged to power the electronic device. The charging and discharging can take place within a temperature range between 130° C. and 230° C. and voltage range between 2 V and 4.2 V, and will result in a safety coefficient greater in the range of 1,000 to 20,000. In some variations, the cathode is made, at least in part, of LiMn₂O₄. In some variations, the lithium ion cell does not contain a solid electrolyte interface layer. In some variations, the lithium ion cell comprises an aluminum current collector. In some variations, the lithium ion cell does not include a copper current collector. In some variations, the lithium ion cell has a cycle life of at least 3,000 cycles. In some variations, the lithium ion cell has a calendar life of 5-9 years. In some variations, the lithium ion cell has a calendar life of 10-15 years. In some variations, the lithium ion cell does not contain lead, nickel, cadmium, acids, or caustics in the electrolyte solution.

The methods and apparatus described herein include, in some variations, a method of powering an electronic device with a lithium ion cell that has a cathode and an anode. The anode is made, at least in part, of nano-crystalline Li₄Ti₅O₁₂. The lithium ion cell is charged. The lithium ion cell is discharged to power the electronic device. The charging and discharging can take place within a temperature range between −50° C. and 0° C. and voltage range between 2 V and 4.2 V, and will result in a safety coefficient greater in the range of 1,000 to 20,000. In some variations, the cathode is made, at least in part, of LiMn₂O₄. In some variations, the lithium ion cell does not contain a solid electrolyte interface layer. In some variations, the lithium ion cell comprises an aluminum current collector. In some variations, the lithium ion cell does not include a copper current collector. In some variations, the lithium ion cell has a cycle life of at least 3,000 cycles. In some variations, the lithium ion cell has a calendar life of 5-9 years. In some variations, the lithium ion cell has a calendar life of 10-15 years. In some variations, the lithium ion cell does not contain lead, nickel, cadmium, acids, or caustics in the electrolyte solution.

The methods and apparatus described herein include, in some variations, a computer-readable storage medium that contains computer-executable instructions to charge and discharge a lithium ion cell to power an electric device, comprising instructions to: charge the lithium ion cell; and discharg the lithium ion cell to power the electronic device. The lithium ion cell can be charged and discharged within a temperature range between 130° C. and 250° C. and voltage range between 1.5 V and 4.2 V. The charging and discharging of the lithium ion cell results in a safety coefficient greater than 100. The lithium ion cell comprises a cathode and an anode. The anode is made, at least in part, of nano-crystalline Li₄Ti₅O₁₂. In some variations, the cathode is made, at least in part, of LiMn₂O₄. In some variations, the lithium ion cell does not contain a solid electrolyte interface layer. In some variations, the lithium ion cell comprises an aluminum current collector. In some variations, the lithium ion cell does not include a copper current collector. In some variations, the lithium ion cell has a cycle life of at least 3,000 cycles. In some variations, the lithium ion cell has a calendar life of 5-9 years. In some variations, the lithium ion cell has a calendar life of 10-15 years. In some variations, the lithium ion cell does not contain lead, nickel, cadmium, acids, or caustics in the electrolyte solution.

The methods and apparatus described herein include, in some variations, a computer-readable storage medium that contains computer-executable instructions to charge and discharge a lithium ion cell to power an electric device, comprising instructions to: charge the lithium ion cell; and discharg the lithium ion cell to power the electronic device. The lithium ion cell can be charged and discharged within a temperature range between −50° C. and 5° C. and voltage range between 1.5 V and 4.2 V. The charging and discharging of the lithium ion cell results in a safety coefficient greater than 100. The lithium ion cell comprises a cathode and an anode. The anode is made, at least in part, of nano-crystalline Li₄Ti₅O₁₂. In some variations, the cathode is made, at least in part, of LiMn₂O₄. In some variations, the lithium ion cell does not contain a solid electrolyte interface layer. In some variations, the lithium ion cell comprises an aluminum current collector. In some variations, the lithium ion cell does not include a copper current collector. In some variations, the lithium ion cell has a cycle life of at least 3,000 cycles. In some variations, the lithium ion cell has a calendar life of 5-9 years. In some variations, the lithium ion cell has a calendar life of 10-15 years. In some variations, the lithium ion cell does not contain lead, nickel, cadmium, acids, or caustics in the electrolyte solution.

The methods and apparatus described herein include, in some variations, a measurement-while-drilling apparatus that had a lithium ion cell that can operate within a temperature range between 130° C. and 250° C. The lithium ion cell has an anode and cathode. The anode is made, at least in part, of nano-crystalline Li₄Ti₅O₁₂. In some variations, the cathode is made, at least in part, of LiMn₂O₄. In some variations, the lithium ion cell does not contain a solid electrolyte interface layer. In some variations, the lithium ion cell comprises an aluminum current collector. In some variations, the lithium ion cell does not include a copper current collector. In some variations, the lithium ion cell has a cycle life of at least 3,000 cycles. In some variations, the lithium ion cell has a calendar life of 5-9 years. In some variations, the lithium ion cell has a calendar life of 10-15 years. In some variations, the lithium ion cell does not contain lead, nickel, cadmium, acids, or caustics in the electrolyte solution. In some variations, the apparatus has a battery management system. In some variations, the battery management system has a processor and memory. In some variations, the apparatus can be operated for its intended purpose within a battery safety coefficient range of greater than 1,000 and less than 20,000.

The methods and apparatus described herein include, in some variations, a logging-while-drilling apparatus that has a lithium ion cell that can operate within a temperature range between 130° C. and 250° C. The lithium ion cell has an anode and cathode. The anode is made, at least in part, of nano-crystalline Li₄Ti₅O₁₂. In some variations, the cathode is made, at least in part, of LiMn₂O₄. In some variations, the lithium ion cell does not contain a solid electrolyte interface layer. In some variations, the lithium ion cell comprises an aluminum current collector. In some variations, the lithium ion cell does not include a copper current collector. In some variations, the lithium ion cell has a cycle life of at least 3,000 cycles. In some variations, the lithium ion cell has a calendar life of 5-9 years. In some variations, the lithium ion cell has a calendar life of 10-15 years. In some variations, the lithium ion cell does not contain lead, nickel, cadmium, acids, or caustics in the electrolyte solution. In some variations, the apparatus has a battery management system. In some variations, the battery management system has a processor and memory. In some variations, the apparatus can be operated for its intended purpose within a battery safety coefficient range of greater than 1,000 and less than 20,000.

The methods and apparatus described herein include, in some variations, a geocentric artificial satellite apparatus that has a lithium ion cell that can operate within a temperature range between −50° C. and 0° C. The lithium ion cell has an anode and cathode. The anode is made, at least in part, of nano-crystalline Li₄Ti₅O₁₂. In some variations, the cathode is made, at least in part, of LiMn₂O₄. In some variations, the lithium ion cell does not contain a solid electrolyte interface layer. In some variations, the lithium ion cell comprises an aluminum current collector. In some variations, the lithium ion cell does not include a copper current collector. In some variations, the lithium ion cell has a cycle life of at least 3,000 cycles. In some variations, the lithium ion cell has a calendar life of 5-9 years. In some variations, the lithium ion cell has a calendar life of 10-15 years. In some variations, the lithium ion cell does not contain lead, nickel, cadmium, acids, or caustics in the electrolyte solution. In some variations, the apparatus has a battery management system. In some variations, the battery management system has a processor and memory. In some variations, the apparatus can be operated for its intended purpose within a battery safety coefficient range of greater than 1,000 and less than 20,000.

The methods and apparatus described herein include, in some variations, a spacecraft apparatus that has a lithium ion cell that can operate within a temperature range between −50° C. and 0° C. The lithium ion cell has an anode and cathode. The anode is made, at least in part, of nano-crystalline Li₄Ti₅O₁₂. In some variations, the cathode is made, at least in part, of LiMn₂O₄. In some variations, the lithium ion cell does not contain a solid electrolyte interface layer. In some variations, the lithium ion cell comprises an aluminum current collector. In some variations, the lithium ion cell does not include a copper current collector. In some variations, the lithium ion cell has a cycle life of at least 3,000 cycles. In some variations, the lithium ion cell has a calendar life of 5-9 years. In some variations, the lithium ion cell has a calendar life of 10-15 years. In some variations, the lithium ion cell does not contain lead, nickel, cadmium, acids, or caustics in the electrolyte solution. In some variations, the apparatus has a battery management system. In some variations, the battery management system has a processor and memory. In some variations, the apparatus can be operated for its intended purpose within a battery safety coefficient range of greater than 1,000 and less than 20,000.

The methods and apparatus described herein include, in some variations, an aircraft apparatus that has a lithium ion cell that can operate within a temperature range between 130° C. and 250° C. The lithium ion cell has an anode and cathode. The anode is made, at least in part, of nano-crystalline Li₄Ti₅O₁₂. In some variations, the cathode is made, at least in part, of LiMn₂O₄. In some variations, the lithium ion cell does not contain a solid electrolyte interface layer. In some variations, the lithium ion cell comprises an aluminum current collector. In some variations, the lithium ion cell does not include a copper current collector. In some variations, the lithium ion cell has a cycle life of at least 3,000 cycles. In some variations, the lithium ion cell has a calendar life of 5-9 years. In some variations, the lithium ion cell has a calendar life of 10-15 years. In some variations, the lithium ion cell does not contain lead, nickel, cadmium, acids, or caustics in the electrolyte solution. In some variations, the apparatus has a battery management system. In some variations, the battery management system has a processor and memory. In some variations, the apparatus can be operated for its intended purpose within a battery safety coefficient range of greater than 1,000 and less than 20,000.

### BRIEF DESCRIPTION OF THE DRAWINGS

FIG. 1 depicts a graph of cell voltage (V) and cell temperature (° C.) versus time (minutes) of a LTO cell in a 240° C. hot box.

FIG. 2(a) depicts a graph of cell voltage (V) and cell temperature (° C.) versus percent over capacity of a LTO cell at a 20° C. forced overcharge rate.

FIG. 2(b) depicts a graph of cell voltage versus time and capacity of a LTO cell and LCO cell during forced overcharge.

FIG. 3 illustrates a battery management system that may be employed to carry out processing functionality in some variations of the methods described herein.

### DETAILED DESCRIPTION OF THE INVENTION

In order to provide a more thorough understanding of the present invention, the following description sets forth numerous specific details, such as specific methods, parameters, examples, and the like. It should be recognized, however, that such description is not intended as a limitation on the scope of the present invention, but is intended to provide a better understanding of the possible variations. All patents, scientific articles, and other publications recited in this specification are hereby incorporated by reference in their entirety for all purposes.

### Traditional Lithium Ion Cell Safety Issues

The temperature of a cell is determined by the net heat flow between the heat generated and heat dissipated. When traditional cells get heated to about 130° C., exothermic chemical reactions between the electrodes and electrolyte occur, raising the cell's internal temperature. If the heat generated is more than can be dissipated, the exothermic processes can rapidly increase. The rise in temperature can further accelerate the chemical reaction, causing even more heat to be produced, eventually resulting in thermal runaway. Furthermore, any pressure generated in this process can cause mechanical failures within cells, triggering short circuits, premature death of the cell, distortion, swelling, and rupture.

Possible exothermic reactions that trigger thermal runaway can include: thermal decomposition of the electrolyte; reduction of the electrolyte by the anode; oxidation of the electrolyte by the cathode; thermal decomposition of the anode and cathode; and melting of the separator and the consequent internal short. Thermal runaway is often a result of abusive conditions, including: overheating, overcharging, high pulse power, physical damage, and internal or external short circuit.

### LTO Safety Improvements

The introduction of nanosized Lithium titanate, Li₄Ti₅O₁₂ (“LTO”), anodes for lithium ion batteries allows for a wider range of safe operating conditions.

Traditional lithium ion batteries must be controlled to operate within a narrow voltage and temperature window. The window for traditional lithium ion batteries is typically between 2.0 V and 4.2 V and 0° C. to 130° C. In contrast, lithium titanate-based cells, as described herein, need no controls and are not confined to a narrow voltage and temperature window. The LTO cells, for example, oftentimes function well substantially below 2.0 V and substantially above 4.2 V and operate from −50° C. to almost 250° C.

Traditional lithium ion cells have six failure modes. They use graphite anodes, which enable four of the six modes and serve as catalysts to thermal runaway. Thus, operating parameters must be carefully controlled with electronics.

Lithium titanate has a 1.5V potential as compared to lithium. LTO-based cells allow improved safety designs, which eliminate catalysts leading to thermal runaway. Such LTO cells do not require controls or electronics to provide improved safety parameters. LTO-based cells have failure modes similar to those of other rechargeable chemistries e.g., NiCd, NiMH, and Pb acid.

### Safe Operational Ranges

In order to provide a more thorough understanding of the present invention, the following description sets forth six ranges of varying temperatures and voltages, and discusses the behavior of LTO and traditional non-TLO in each range. It should be recognized, however, that such description is not intended as a limitation on the scope of the present invention, but is intended to provide a better understanding of the possible variations.

Range 1, which corresponds to operating temperatures approximately 250° C. and above, is known as the thermal runaway range and should be avoided for both traditional lithium ion batteries and lithium titanate-based batteries. The exact onset temperature and heat flow of range 1 depend upon the cathode material. At the onset temperature, the cathode material decomposes, releasing oxygen and leading to electrolyte decomposition. Additional heat is produced within seconds, which can yield thermal runaway, disassembly, and oftentimes fire.

Range 2 corresponds to voltages up to 4.2 and temperatures between 130° C. and approximately 250° C. This range corresponds to solid electrolyte interface (“SEI”) layer breakdown. At first charge, the organic solvents of the cell are decomposed and form a SEI layer.

All graphite/carbon-based lithium-ion cells have an SEI layer on the anode. It is necessary to prevent degradation of graphite.

At approximately 130° C., the initial SEI layer begins to break down; heat is released. With the temperature increase the secondary SEI layer begins a cycle of lithium de-intercalation and heat release. Such decomposition can lead to thermal runaway (Range 1) due to the gradual heat rise.

Lithium titanate-based cells neither have nor need an SEI layer. LTO has an electrochemical potential of 1.55 V versus 0.15 V for graphite. This inhibits breakdown of the electrolyte and prevents SEI from forming on first cycle formation.

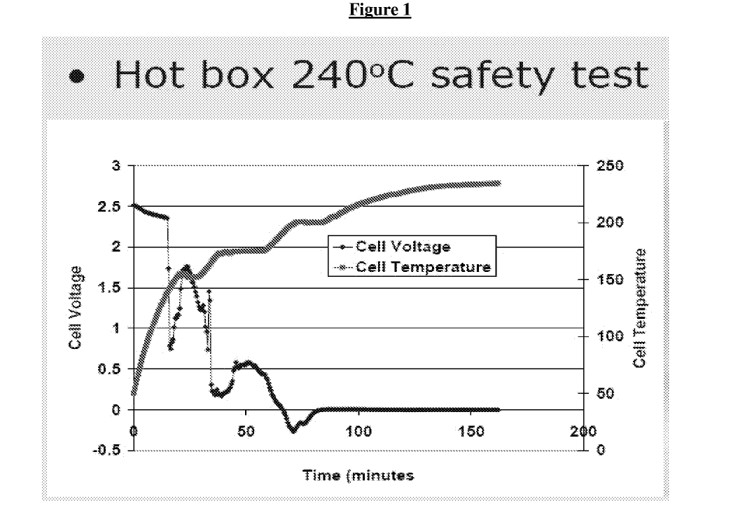

Referring to FIG. 1, which depicts a graph of cell voltage (V) and cell temperature (° C.) versus time (minutes) of a LTO cell in a 240° C. hot box, the temperature of the cell gradually increases to 250° C. and plateaus. The LTO cell does not experience an accelerated temperature increase that would be indicative of thermal runaway.

Range 3 corresponds to voltages above 4.2 V and temperatures between 20° C. and 130° C. In a traditional lithium-ion battery, Range 3 is entered by cell overcharging. Overcharging the cathode reduces the onset temperature of Range 1. In addition, the heat flow increases; lithium plates on the anode; metal particles in the cell create shorts and more heating. Overcharging furthermore creates heat, which breaks down the SEI layer.

LTO, which has a 1.55 V potential versus lithium, does not allow plating of lithium on LTO. For lithium plating to occur, one needs to be near 0 V potential (i.e., graphite).

Traditional lithium ion batteries oversize anode capacity. This reduces the risk of lithium plating on the anode. It does not, however, eliminate risk; it simply adds a buffer before plating occurs. This provides a design tradeoff: The cathode is more easily overcharged (delithiated), and therefore quickly reduces thermal runaway temperature.

LTO cells can oversize cathode capacity. One is not concerned about plating lithium on the anode. The larger cathode capacity decreases the chance of overcharge, and the thermal runaway temperature stays consistent.

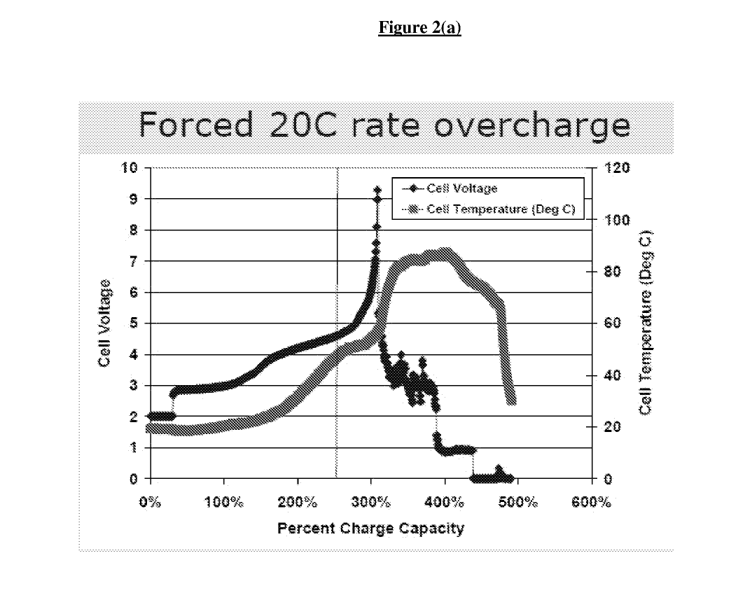

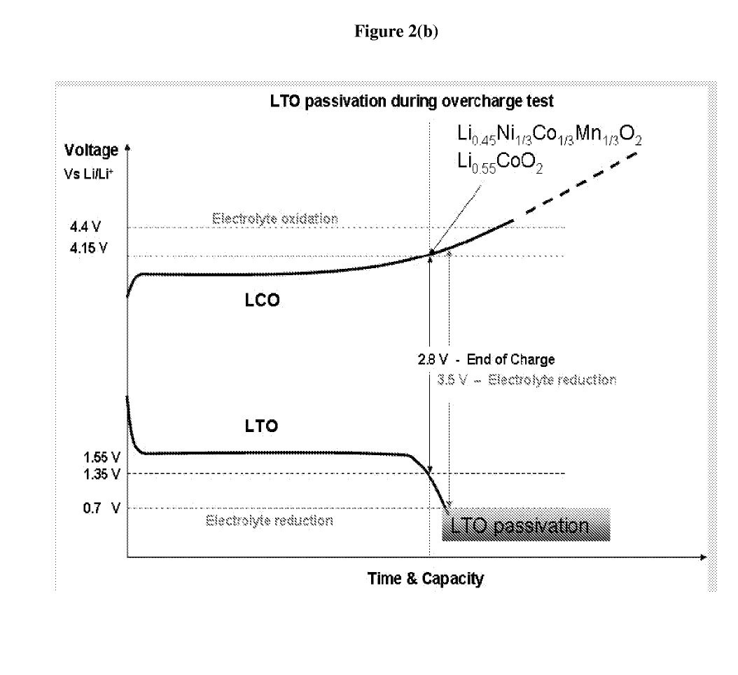

Referring to FIG. 2(a), which depicts a graph of cell voltage (V) and cell temperature (° C.) versus percent over capacity of a LTO cell at a 20 C forced overcharge rate, the temperature of the cell increases gradually to about 90° C. and then falls. The LTO cell does not experience a continued accelerated in temperature increase that would be indicative of thermal runaway. Referring to FIG. 2(b), which depicts a graph of cell voltage versus time and capacity of a LTO cell and LCO cell during forced overcharge, the LTO cell under goes a passivation process, rather than thermal runaway, as exhibited in the LCO cell.

Range 4 corresponds to cell voltages below 2.0 V and temperatures ranging from 20° C. to 130° C. Traditional lithium-ion cells are made with a copper current collector in the anode. During overdischarge (<2.0 volts), or reversal of polarity, the potential of the graphite anode rises above the potential of the copper current collector. This causes copper dissolution.

Copper begins to dissolve and migrates through the separator. If the cell is at reversed polarity, it plates on the cathode and causes short circuits. Severe, continued overdischarge can lead to temperature increases and thermal runaway.

LTO electrodes operate at ˜1.5 V and typically do not use copper current collectors. LTO cells typically use aluminum for both current collectors, which obviates copper dissolution as an issue. Standard lithium ion batteries cannot use an aluminum collector at the anode due to lithium-aluminum alloy formation.

Range 5 corresponds to operating temperatures less than 0° C. In traditional lithium-ion cells, the diffusion of lithium ions through the interface (SEI) accounts for a significant portion of observed, high impedance. The high impedance prevents charging at low temperatures and leads to lithium plating-—in the form of lithium dendrites—on the surface of the anode. This reduces the life of the cell and typically does not lead to Range 1 or Range 6. A large amount of lithium dendrites may cause soft shorts that may cause hard shorts and finally result in thermal runaway. LTO, in contrast, does not have the resistive SEI layer and does not have a lithium plating issue.

Range 6 corresponds to voltages above 4.2 V and temperatures between 130° C. and 250° C. Under severe abuse, LTO cells will vaporize electrolyte and vent. The vaporized electrolyte is highly flammable and can ignite in the presence of oxygen and an ignition source.

In some variations, liquid electrolytes in lithium ion batteries consist of solid lithium-salt electrolytes, such as LiPF₆, LiBF₄, or LiClO₄, and organic solvents, such as ether, and do not contain lead, nickel, cadmium, acids, or caustics.

### Safety Coefficients

To better compare the relative safety of various lithium ion cells, a safety coefficient can be determined. A safety coefficient can be calculated by: first, determining the number of thermal runaway events that occur during a given period of time; second, determine the number of times, or cycles, a cell was fully charged and discharged during the same given period of time; third, divide the determined number of fully charged and discharged cycles by the determined number of thermal runaway events.

$$Safety Coefficient = \frac{Number of Full Charge and Discharge Cycles}{Number of Thermal Runaway Events} \qquad ( Eq . 1 )$$

Wherein Thermal Runaway Event=greater than 50° C. temperature increase over baseline due to exothermic chemical reactions occurring within the cell. Where the safety coefficient is determined over a number of cells of similar/same composition, the number is an average of the various individual coefficients.

Typically at a cell voltage ranging from 2.0 to 2.5 V and a temperature ranging between 130° C. and 180° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 2.0 to 2.5 V and a temperature ranging between 180° C. and 250° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 2.5 to 3.0 V and a temperature ranging between 130° C. and 180° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 2.5 to 3.0 V and a temperature ranging between 180° C. and 250° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 3.0 to 3.5 V and a temperature ranging between 130° C. and 180° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 3.0 to 3.5 V and a temperature ranging between 180° C. and 250° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 3.5 to 4.0 V and a temperature ranging between 130° C. and 180° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 3.5 to 4.0 V and a temperature ranging between 180° C. and 250° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 4.0 to 4.2 V and a temperature ranging between 130° C. and 180° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 4.0 to 4.2 V and a temperature ranging between 180° C. and 250° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage above 4.2 V and a temperature ranging between 20° C. and 80° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage above 4.2 V and a temperature ranging between 80° C. and 130° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage above 4.3 V and a temperature ranging between 20° C. and 80° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage above 4.3 V and a temperature ranging between 80° C. and 130° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage above 4.4 V and a temperature ranging between 20° C. and 80° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage above 4.4 V and a temperature ranging between 80° C. and 130° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage below 2.0 V and a temperature ranging between 20° C. and 80° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage below 2.0 V and a temperature ranging between 80° C. and 130° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage below 1.9 V and a temperature ranging between 20° C. and 80° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage below 1.9 V and a temperature ranging between 80° C. and 130° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage below 1.8 V and a temperature ranging between 20° C. and 80° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage below 1.8 V and a temperature ranging between 80° C. and 130° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 2.0 to 2.5 V and a temperature below 0° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 2.5 to 3.0 V and a temperature below 0° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 3.0 to 3.5 V and a temperature below 0° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 3.5 to 4.0 V and a temperature below 0° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 4.0 to 4.2 V and a temperature below 0° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 4.2 to 4.4 V and a temperature below 0° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 2.0 to 2.5 V and a temperature below −10° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 2.5 to 3.0 V and a temperature below −10° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 3.0 to 3.5 V and a temperature below −10° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 3.5 to 4.0 V and a temperature below −10° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 4.0 to 4.2 V and a temperature below −10° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 4.2 to 4.4 V and a temperature below −10° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 2.0 to 2.5 V and a temperature below −20° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 2.5 to 3.0 V and a temperature below −20° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 3.0 to 3.5 V and a temperature below −20° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 3.5 to 4.0 V and a temperature below −20° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 4.0 to 4.2 V and a temperature below −20° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage ranging from 4.2 to 4.4 V and a temperature below −20° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage above 4.2 V and a temperature ranging between 130° C. and 170° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage above 4.2 V and a temperature ranging between 170° C. and 250° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage above 4.3 V and a temperature ranging between 130° C. and 170° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage above 4.3 V and a temperature ranging between 170° C. and 250° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage above 4.4 V and a temperature ranging between 130° C. and 170° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

Typically at a cell voltage above 4.4 V and a temperature ranging between 170° C. and 250° C., the cell has a safety coefficient greater than 100, 250 or 500. Oftentimes, the cell has a safety coefficient greater than 1,000, 2,000 or 3,000. In certain cases, the cell has a safety coefficient greater than 5,000, 10,000 or 15,000.

### Applications

Various industries and devices could be served with lithium ion batteries that safely operate in a wider range of conditions. In the broadest sense, any application requiring safe operation of battery technology may be used in the methods, and with the apparatus, described herein.

In order to provide a more thorough understanding of the present invention, the following description sets forth numerous specific applications of the methods and apparatus described herein. It should be recognized, however, that such description is not intended as a limitation on the scope of the present invention of the application thereof, but is intended to provide a better understanding of the possible variations.

Geothermal and deep oil and natural gas fields require high-temperature drilling systems that can operate at 150-230° C. The challenges of reaching the targets in these fields typically require the use of measurement-while-drilling (“MWD”) tools during drilling, which in turn require high-temperature-capable battery power.

MWD and logging-while-drilling (“LWD”) tools are powered by an autonomous power source. Many tools operate at temperatures below 150° C. mainly because their components, including the battery, cannot operate at higher temperatures. Drilling and logging services need batteries that can safely operate at high temperatures, increasing the temperature limits of the tools they operate. The drilling industry continues to drill deeper and hotter wells to support fossil fuel exploration and production, and geothermal power production. Natural gas well temperatures in excess of 185° C. are becoming increasingly common. The logging and drilling tools require electronics that operate with a high degree of reliability while at elevated temperatures.

Other non-limiting examples of high-temperature applications could be aircraft apparatus, such as an engine power supply or onboard power supply.

In addition to apparatus operating at high temperatures, the apparatus and processes disclosed herein can also be utilized in low-temperature environments. Non-limiting examples include apparatus operating in outer space (or at elevations greater than 75 miles), such as geocentric satellites or spacecraft.

A geocentric satellite is any object orbiting the Earth, such as the Moon or artificial satellites. Currently, there are approximately 2,465 artificial satellites orbiting the Earth. Some non-limiting examples of geocentric artificial satellites are astronomical satellites, biosatellites, communications satellites, miniaturized satellites, navigational satellites, reconnaissance satellites, Earth observation satellites, space stations, tether satellites, weather satellites, and anti-satellite or other weapons in orbit.

Additionally, in some variations an apparatus could be required to operate in both high-temperature and low-temperature environments, such as high altitude aircraft or deep ocean drilling.

### Battery Management System

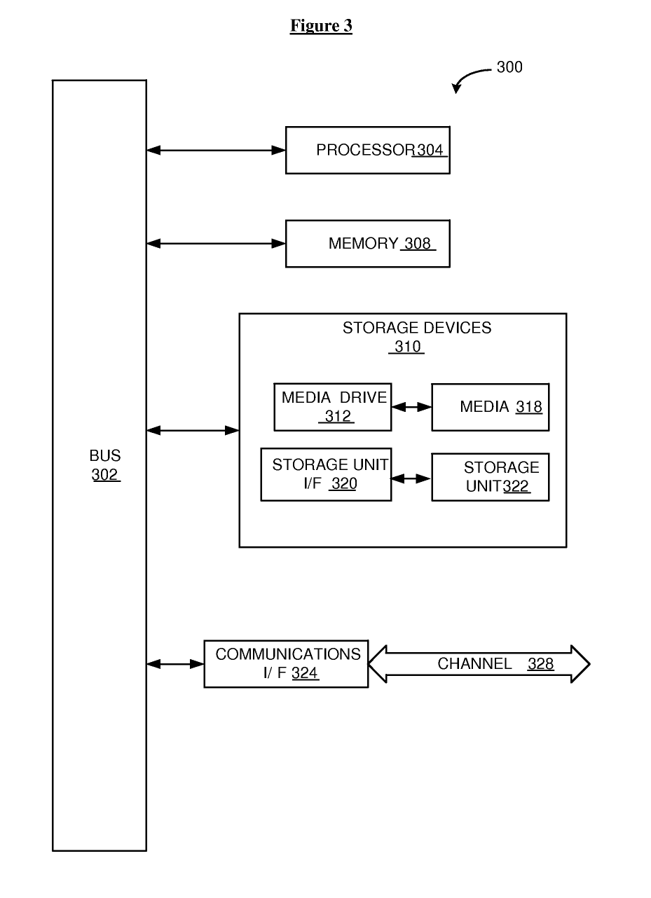

FIG. 3 illustrates a typical computing or Battery management system 300 that may be employed to carry out processing functionality in some variations of the process. Those skilled in the relevant art will also recognize how to implement the invention using other computer systems or architectures. Battery management system 300 may represent, for example, a desktop, laptop, or notebook computer, hand-held computing device (PDA, cell phone, palmtop, etc.), mainframe, supercomputer, server, client, or any other type of special or general purpose computing device as may be desirable or appropriate for a given application or environment. Battery Management System 300 can include one or more processors, such as a processor 304. Processor 304 can be implemented using a general or special purpose processing engine such as, for example, a microprocessor, controller, or other control logic. In this example, processor 304 is connected to a bus 302 or other communication medium.

Battery management system 300 can also include a main memory 308, preferably random access memory (“RAM”) or other dynamic memory, for storing information and instructions to be executed by processor 304. Main memory 308 also may be used for storing temporary variables or other intermediate information during execution of instructions to be executed by processor 304. Battery management system 300 may likewise include a read only memory (“ROM”) or other static storage device coupled to bus 302 for storing static information and instructions for processor 304.

The battery management system 300 may also include information storage mechanism 310, which may include, for example, a media drive 312 and a removable storage interface 320. The media drive 312 may include a drive or other mechanism to support fixed or removable storage media, such as a hard disk drive, a floppy disk drive, a magnetic tape drive, an optical disk drive, a CD or DVD drive (R or RW), or some other removable or fixed media drive. Storage media 318 may include, for example, a hard disk, floppy disk, magnetic tape, optical disk, CD or DVD, or other fixed or removable medium that is read by and written to media drive 312. As these examples illustrate, the storage media 318 may include a computer-readable storage medium having stored therein particular computer software or data.

In some variations, information storage mechanism 310 may include other similar instrumentalities for allowing computer programs or other instructions or data to be loaded into battery management system 300. Such instrumentalities may include, for example, a removable storage unit 322 and an interface 320, such as a program cartridge and cartridge interface, a removable memory (for example, a flash memory or other removable memory module) and memory slot, and other removable storage units 322 and interfaces 320 that allow software and data to be transferred from the removable storage unit 322 to battery management system 300.

In some variations, battery management system 300 can also include a communications interface 324. Communications interface 324 can be used to allow software and data to be transferred between battery management system 300 and external devices. Non-limiting examples of communications interface 324 can include a modem, a network interface (such as an Ethernet or other NIC card), a communications port (such as for example, a USB port), a PCMCIA slot and card, etc. Software and data transferred via communications interface 324 are in the form of signals which can be electronic, electromagnetic, optical, or other signals capable of being received by communications interface 324. These signals are provided to communications interface 324 via a channel 328. This channel 328 may carry signals and may be implemented using a wireless medium, wire or cable, fiber optics, or other communications medium. Some examples of a channel include a phone line, a cellular phone link, an RF link, a network interface, a local or wide area network, and other communications channels.

The terms “computer program product” and “computer-readable storage medium” may be used generally to refer to media such as, for example, memory 308, storage device 310, storage unit 322, or signal(s) on channel 328. These and other forms of computer-readable storage media may be involved in providing one or more sequences of one or more instructions to processor 304 for execution. Such instructions, generally referred to as “computer program code” (which may be grouped in the form of computer programs or other groupings), when executed, enable the battery management system 300 to perform features or functions of embodiments of the present invention.

In some variations where the elements are implemented using software, the software may be stored in a computer-readable storage medium and loaded into battery management system 300 using, for example, removable media drive 312 or communications interface 324. The control logic (in this example, software instructions or computer program code), when executed by the processor 304, causes the processor 304 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor, or controller. Hence, references to specific functional units are only to be seen as references to suitable means for providing the described functionality, rather than as indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements, or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Terms and phrases used in this document, and variations thereof unless otherwise expressly stated, should be construed as open ended as opposed to limiting. As examples of the foregoing: the term “including” should be read to mean “including, without limitation” or the like; the terms “example” and “some variations” are used to provide exemplary instances of the item in discussion, not an exhaustive or limiting list thereof; and adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements, or components of the invention may be described or claimed in the singular, the plural is contemplated to be within the scope thereof unless limitation to the singular is explicitly stated. The presence of broadening words and phrases such as “one or more,” “at least,” “but not limited to,” “in some variations,” or other like phrases in some instances shall not be read to mean that the narrower case is intended or required in instances where such broadening phrases may be absent.

1. A method of powering an electronic device, comprising:
a) providing an electronic device comprising a lithium ion cell wherein the lithium ion cell comprises an anode and cathode wherein the anode comprises nano-crystalline Li₄Ti₅O₁₂;
b) charging the lithium ion cell; and
c) discharging the lithium ion cell to power the electronic device; wherein the lithium ion cell can be charged and discharged within a temperature range between 130° C. and 250° C. and voltage range between 1.5 V and 4.2 V, and wherein the charging and discharging of the lithium ion cell results in a safety coefficient greater than 100.

2. The method of claim 1, wherein the cathode comprises LiMn₂O₄.

3. The method of claim 1, wherein the lithium ion cell does not contain a solid electrolyte interface layer.

4. The method of claim 1, wherein the lithium ion cell comprises an aluminum current collector.

5. The method of claim 1, wherein the lithium ion cell does not include a copper current collector.

6. The method of claim 1, wherein the lithium ion cell has a cycle life of at least 3,000 cycles.

7. The method of claim 1, wherein the lithium ion cell has a calendar life of 5-9 years.

8. The method of claim 1, wherein the lithium ion cell has a calendar life of 10-15 years.

9. The method of claim 1, wherein the lithium ion cell does not contain lead, nickel, cadmium, acids, or caustics in the electrolyte solution.

10. A method of powering an electronic device, comprising:
a) providing an electronic device comprising a lithium ion cell wherein the lithium ion cell comprises an anode and cathode wherein the anode comprises nano-crystalline Li₄Ti₅O₁₂;
b) charging the lithium ion cell; and
c) discharging the lithium ion cell to power the electronic device; wherein the lithium ion cell can be charged and discharged within a temperature range between −50° C. and 5° C. and voltage range between 1.5 V and 4.2 V, and wherein the operation results in a safety coefficient greater than 100.

11. The method of claim 10, wherein the cathode comprises LiMn₂O₄.

12. The method of claim 10, wherein the lithium ion cell does not contain a solid electrolyte interface layer.

13. The method of claim 10, wherein the lithium ion cell comprises an aluminum current collector.

14. The method of claim 10, wherein the lithium ion cell does not include a copper current collector.

15. The method of claim 10, wherein the lithium ion cell has a cycle life of at least 3,000 cycles.

16. The method of claim 10, wherein the lithium ion cell has a calendar life of 5-9 years.

17. The method of claim 10, wherein the lithium ion cell has a calendar life of 10-15 years.

18. The method of claim 10, wherein the lithium ion cell does not contain lead, nickel, cadmium, acids, or caustics in the electrolyte solution.

19. A method of powering an electronic device, comprising:
a) providing an electronic device comprising a lithium ion cell wherein the lithium ion cell comprises an anode and cathode wherein the anode comprises nano-crystalline Li₄Ti₅O₁₂;
b) charging the lithium ion cell; and
c) discharging the lithium ion cell to power the electronic device; wherein the lithium ion cell can be charged and discharged within a temperature range between 130° C. and 230° C. and voltage range between 2 V and 4.2 V, and wherein the operation results in a safety coefficient greater than 1,000 and less than 20,000.

20. The method of claim 19, wherein the cathode comprises LiMn₂O₄.

21. The method of claim 19, wherein the lithium ion cell does not contain a solid electrolyte interface layer.

22. The method of claim 19, wherein the lithium ion cell comprises an aluminum current collector.

23. The method of claim 19, wherein the lithium ion cell does not include a copper current collector.

24. The method of claim 19, wherein the lithium ion cell has a cycle life of at least 3,000 cycles.

25. The method of claim 19, wherein the lithium ion cell has a calendar life of 5-9 years.

26. The method of claim 19, wherein the lithium ion cell has a calendar life of 10-15 years.

27. The method of claim 19, wherein the lithium ion cell does not contain lead, nickel, cadmium, acids, or caustics in the electrolyte solution.

28. A method of powering an electronic device, comprising:
a) providing an electronic device comprising a lithium ion cell wherein the lithium ion cell comprises an anode and cathode wherein the anode comprises nano-crystalline Li₄Ti₅O₁₂;
b) charging the lithium ion cell; and
c) discharging the lithium ion cell to power the electronic device; wherein the lithium ion cell can be charged and discharged within a temperature range between −50° C. and 0° C. and voltage range between 2 V and 4.2 V, and wherein the operation results in a safety coefficient greater than 1,000 and less than 20,000.

29. The method of claim 28, wherein the cathode comprises LiMn₂O₄.

30. The method of claim 28, wherein the lithium ion cell does not contain a solid electrolyte interface layer.

31. The method of claim 28, wherein the lithium ion cell comprises an aluminum current collector.

32. The method of claim 28, wherein the lithium ion cell does not include a copper current collector.

33. The method of claim 28, wherein the lithium ion cell has a cycle life of at least 3,000 cycles.

34. The method of claim 28, wherein the lithium ion cell has a calendar life of 5-9 years.

35. The method of claim 28, wherein the lithium ion cell has a calendar life of 10-15 years.

36. The method of claim 28, wherein the lithium ion cell does not contain lead, nickel, cadmium, acids, or caustics in the electrolyte solution.

37. A computer-readable storage medium containing computer-executable instructions to charge and discharge a lithium ion cell to power an electric device, comprising instructions to:
charge the lithium ion cell;
discharging the lithium ion cell to power the electronic device; wherein the lithium ion cell can be charged and discharged within a temperature range between 130° C. and 250° C. and voltage range between 1.5 V and 4.2 V, and wherein the charging and discharging of the lithium ion cell results in a safety coefficient greater than 100, and wherein the lithium ion cell comprises a cathode and an anode wherein the anode comprising nano-crystalline Li₄Ti₅O₁₂.

38. The computer-readable storage medium of claim 37, wherein the cathode comprises LiMn₂O₄.

39. The computer-readable storage medium of claim 37, wherein the lithium ion cell does not contain a solid electrolyte interface layer.

40. The computer-readable storage medium of claim 37, wherein the lithium ion cell comprises an aluminum current collector.

41. The computer-readable storage medium of claim 37, wherein the lithium ion cell does not include a copper current collector.

42. The computer-readable storage medium of claim 37, wherein the lithium ion cell has a cycle life of at least 3,000 cycles.

43. The computer-readable storage medium of claim 37, wherein the lithium ion cell has a calendar life of 5-9 years.

44. The computer-readable storage medium of claim 37, wherein the lithium ion cell has a calendar life of 10-15 years.

45. The computer-readable storage medium of claim 37, wherein the lithium ion cell does not contain lead, nickel, cadmium, acids, or caustics in the electrolyte solution.

46. A computer-readable storage medium containing computer-executable instructions to charge and discharge a lithium ion cell to power an electric device, comprising instructions to:
charge the lithium ion cell;
discharging the lithium ion cell to power the electronic device; wherein the lithium ion cell can be charged and discharged within a temperature range between −50° C. and 5° C. and voltage range between 1.5 V and 4.2 V, and wherein the charging and discharging of the lithium ion cell results in a safety coefficient greater than 100, and wherein the lithium ion cell comprises an anode and cathode wherein the anode comprises nano-crystalline Li₄Ti₅O₁₂.

47. The computer-readable storage medium of claim 46, wherein the cathode comprises LiMn₂O₄.

48. The computer-readable storage medium of claim 46, wherein the lithium ion cell does not contain a solid electrolyte interface layer.

49. The computer-readable storage medium of claim 46, wherein the lithium ion cell comprises an aluminum current collector.

50. The computer-readable storage medium of claim 46, wherein the lithium ion cell does not include a copper current collector.

51. The computer-readable storage medium of claim 46, wherein the lithium ion cell has a cycle life of at least 3,000 cycles.

52. The computer-readable storage medium of claim 46, wherein the lithium ion cell has a calendar life of 5-9 years.

53. The computer-readable storage medium of claim 46, wherein the lithium ion cell has a calendar life of 10-15 years.

54. The computer-readable storage medium of claim 46, wherein the lithium ion cell does not contain lead, nickel, cadmium, acids, or caustics in the electrolyte solution.

55. A measurement-while-drilling apparatus, wherein the apparatus comprises a lithium ion cell that can operate within a temperature range between 130° C. and 250° C., and wherein the lithium ion cell comprises an anode and cathode wherein the anode comprises nano-crystalline Li₄Ti₅O₁₂.

56. The apparatus of claim 55, wherein the apparatus further comprises a battery management system.

57. The apparatus of claim 56, wherein the battery management system comprises a processor and memory.

58. The apparatus of claim 55, wherein the apparatus can be operated for its intended purpose within a battery safety coefficient range of greater than 1,000 and less than 20,000.

59. The apparatus of claim 55, wherein the cathode comprises LiMn₂O₄.

60. The apparatus of claim 55, wherein the lithium ion cell does not contain a solid electrolyte interface layer.

61. The apparatus of claim 55, wherein the lithium ion cell comprises an aluminum current collector.

62. The apparatus of claim 55, wherein the lithium ion cell does not include a copper current collector.

63. The apparatus of claim 55, wherein the lithium ion cell has a cycle life of at least 3,000 cycles.

64. The apparatus of claim 55, wherein the lithium ion cell has a calendar life of 5-9 years.

65. The apparatus of claim 55, wherein the lithium ion cell has a calendar life of 10-15 years.

66. The apparatus of claim 55, wherein the lithium ion cell does not contain lead, nickel, cadmium, acids, or caustics in the electrolyte solution.

67. A logging-while-drilling apparatus, wherein the apparatus comprises a lithium ion cell that can operate within a temperature range between 130° C. and 250° C., and wherein the lithium ion cell comprises an anode and cathode wherein the anode comprises nano-crystalline Li₄Ti₅O₁₂.

68. The apparatus of claim 67, wherein the apparatus further comprises a battery management system.

69. The apparatus of claim 68, wherein the battery management system comprises a processor and memory.

70. The apparatus of claim 67, wherein the apparatus can be operated for its intended purpose within a battery safety coefficient range of greater than 1,000 and less than 20,000.

71. The apparatus of claim 67, wherein the cathode comprises LiMn₂O₄.

72. The apparatus of claim 67, wherein the lithium ion cell does not contain a solid electrolyte interface layer.

73. The apparatus of claim 67, wherein the lithium ion cell comprises an aluminum current collector.

74. The apparatus of claim 67, wherein the lithium ion cell does not include a copper current collector.

75. The apparatus of claim 67, wherein the lithium ion cell has a cycle life of at least 3,000 cycles.

76. The apparatus of claim 67, wherein the lithium ion cell has a calendar life of 5-9 years.

77. The apparatus of claim 67, wherein the lithium ion cell has a calendar life of 10-15 years.

78. The apparatus of claim 67, wherein the lithium ion cell does not contain lead, nickel, cadmium, acids, or caustics in the electrolyte solution.

79. A geocentric artificial satellite apparatus, wherein the apparatus comprises a lithium ion cell that can operate within a temperature range between −50° C. and 0° C., and wherein the lithium ion cell comprises an anode and cathode wherein the anode comprises nano-crystalline Li₄Ti₅O₁₂.

80. The apparatus of claim 79, wherein the apparatus further comprises a battery management system.

81. The apparatus of claim 80, wherein the battery management system comprises a processor and memory.

82. The apparatus of claim 79, wherein the apparatus can be operated for its intended purpose within a battery safety coefficient range of greater than 1,000 and less than 20,000.

83. The apparatus of claim 79, wherein the cathode comprises LiMn₂O₄.

84. The apparatus of claim 79, wherein the lithium ion cell does not contain a solid electrolyte interface layer.

85. The apparatus of claim 79, wherein the lithium ion cell comprises an aluminum current collector.

86. The apparatus of claim 79, wherein the lithium ion cell does not include a copper current collector.

87. The apparatus of claim 79, wherein the lithium ion cell has a cycle life of at least 3,000 cycles.

88. The apparatus of claim 79, wherein the lithium ion cell has a calendar life of 5-9 years.

89. The apparatus of claim 79, wherein the lithium ion cell has a calendar life of 10-15 years.

90. The apparatus of claim 79, wherein the lithium ion cell does not contain lead, nickel, cadmium, acids, or caustics in the electrolyte solution.

91. A spacecraft apparatus, wherein the apparatus comprises a lithium ion cell that can operate within a temperature range between −50° C. and 0° C., and wherein the lithium ion cell comprises an anode and cathode wherein the anode comprises nano-crystalline Li₄Ti₅O₁₂.

92. The apparatus of claim 91, wherein the apparatus further comprises a battery management system.

93. The apparatus of claim 92, wherein the battery management system comprises a processor and memory.

94. The apparatus of claim 91, wherein the apparatus can be operated for its intended purpose within a battery safety coefficient range of greater than 1,000 and less than 20,000.

95. The apparatus of claim 91, wherein the cathode comprises LiMn₂O₄.

96. The apparatus of claim 91, wherein the lithium ion cell does not contain a solid electrolyte interface layer.

97. The apparatus of claim 91, wherein the lithium ion cell comprises an aluminum current collector.

98. The apparatus of claim 91, wherein the lithium ion cell does not include a copper current collector.

99. The apparatus of claim 91, wherein the lithium ion cell has a cycle life of at least 3,000 cycles.

100. The apparatus of claim 91, wherein the lithium ion cell has a calendar life of 5-9 years.

101. The apparatus of claim 91, wherein the lithium ion cell has a calendar life of 10-15 years.

102. The apparatus of claim 91, wherein the lithium ion cell does not contain lead, nickel, cadmium, acids, or caustics in the electrolyte solution.

103. An aircraft apparatus, wherein the apparatus comprises a lithium ion cell that can operate within a temperature range between 130° C. and 250° C., and wherein the lithium ion cell comprises an anode and cathode wherein the anode comprises nano-crystalline Li₄Ti₅O₁₂.

104. The apparatus of claim 103, wherein the apparatus further comprises a battery management system.

105. The apparatus of claim 104, wherein the battery management system comprises a processor and memory.

106. The apparatus of claim 103, wherein the apparatus can be operated for its intended purpose within a battery safety coefficient range of greater than 1,000 and less than 20,000.

107. The apparatus of claim 103, wherein the cathode comprises LiMn₂O₄.

108. The apparatus of claim 103, wherein the lithium ion cell does not contain a solid electrolyte interface layer.

109. The apparatus of claim 103, wherein the lithium ion cell comprises an aluminum current collector.

110. The apparatus of claim 103, wherein the lithium ion cell does not include a copper current collector.

111. The apparatus of claim 103, wherein the lithium ion cell has a cycle life of at least 3,000 cycles.

112. The apparatus of claim 103, wherein the lithium ion cell has a calendar life of 5-9 years.

113. The apparatus of claim 103, wherein the lithium ion cell has a calendar life of 10-15 years.

114. The apparatus of claim 103, wherein the lithium ion cell does not contain lead, nickel, cadmium, acids, or caustics in the electrolyte solution.
